(19) United States
(12) Patent Application Publication
(10) Pub. No.: US 2012/0138417 A1
(43) Pub. Date: Jun. 7, 2012

(54) PLAY-FREE CLUTCH AND/OR BRAKE

(75) Inventor: Andoitz ARANBURU IRASTORZA, Antzuola (ES)

(73) Assignee: GOIZPER, S. COOP., Antzuola (ES)

(21) Appl. No.: 13/302,542

(22) Filed: Nov. 22, 2011

(30) Foreign Application Priority Data
Dec. 3, 2010 (ES) 201031806

(51) Int. Cl. F16D 67/02

(52) U.S. Cl. 192/18 R

(57) ABSTRACT

Clutch and/or brake device for a machine comprising at least an element which is axially movable along an axial shaft and at least a body for the device characterised in that the axially movable element and the device body are joined by a connection device which, since the connection device is rigid relative to torsional stress about the axial shaft between the axially movable element and the body, comprises at least a flexible element attached by one of its points to the movable axial element and by another point to said body in such a way that a relative movement between the axially movable body and the body produces bending of the flexible element.

The present invention relates to a clutch or combined clutch and brake, preferably for use in fast presses and other types of machines, which provides substantial advantages over those currently known.

In a conventional mechanically-actuated press of the known type, the flywheel accumulates the energy required to accelerate, in each up-down cycle of the slide, the components of the kinematic chain which transform the input rotating motion to an output reciprocating motion and, in particular, provides energy which is used to perform the work of the press; punching, cutting, stamping, etc.

One of the key elements of the kinematic chain of a mechanical press is the clutch-brake portion. The clutch enables the power of the flywheel to be transmitted to the rest of the kinematic chain and the brake allows the slide to be stopped and positioned at will at the cycle start point by separating the motor-flywheel assembly from the rest of the chain. The brake and clutch system may take the form of a compact combined brake and clutch assembly or a separate brake and clutch system.

In a conventional mechanical press of the known type, the operating cycle begins with the clutch disengaged and the brake actuated, keeping the slide in the maximum open position and the flywheel, actuated by the motor, rotating at its rated speed. The start cycle command disengages the brake and engages the clutch, which acts by transmitting energy from the flywheel to accelerate the masses of the kinematic chain, causing the slide to advance to its closing stroke. During this acceleration period, the clutch transmits the maximum torque which is capable of producing a sliding movement until it reaches the speed at which the two sides of the transmission chain are synchronised. This sliding movement produces energy loss in the form of heat in the clutch. The synchronisation speed is lower than the rated speed because the flywheel has transferred energy at the cost of losing speed, and the motor has to restore the rated speed of the system before reaching the slide working position, at which time the clutch has to transmit the torque required to perform the process and this must not exceed the permitted maximum to ensure that no sliding movement occurs. Once the slide has completed its work stroke after passing through the maximum closure point, it begins its return and opening stroke to return to its initial position and stop. The clutch is therefore disengaged, separating the flywheel from the rest of the transmission chain, which allows the motor to recover the speed lost when energy was transferred in the work phase without affecting the rest, and the brake is actuated. When the braking is applied to the masses, a sliding motion occurs until the slide stops at the start point, transforming all the kinetic energy from inertia into heat. The heat generated in the clutch in the acceleration stage and in the brake during braking causes the heating thereof and this has to be dissipated to maintain a suitable stabilisation temperature for correct torque transmission. The fact of not being able to exceed an operating temperature may limit the work rate of the press.

The described manoeuvre is a ‘blow by blow’ operation in which the slide has to stop in each cycle and the brake-clutch components are subjected to the corresponding load at each brake and clutch operation.

It is also possible for the press to work continuously and in this case the slide does not have to wait for the start of each cycle. In these circumstances, the brake and clutch manoeuvres are not performed with sliding except when the press is started and stopped or if there is an emergency shutdown, and therefore no heat is produced. In other words, once the masses have been accelerated and reached work speed, the output shaft (which produces linear movement of the slide directly) rotates continuously at constant speed, the stroke frequency (manufactured parts) coinciding with the rotation of said shaft.

The present invention relates to this type of machine, of which the main feature is that the output shaft rotates at high speed and consequently the reciprocating up-down movement of the slide occurs at a high frequency. This press configuration is normally used for light work such as pressing tin cans or cutting electronic components where production volume takes precedence and crankshaft speeds of up to 250 revolutions per minute (indicating 250 items per minute) may be reached.

The clutches and brakes used to transmit torque in most conventional mechanical presses are widely known devices which can be actuated by air pressure or by another fluid such as oil.

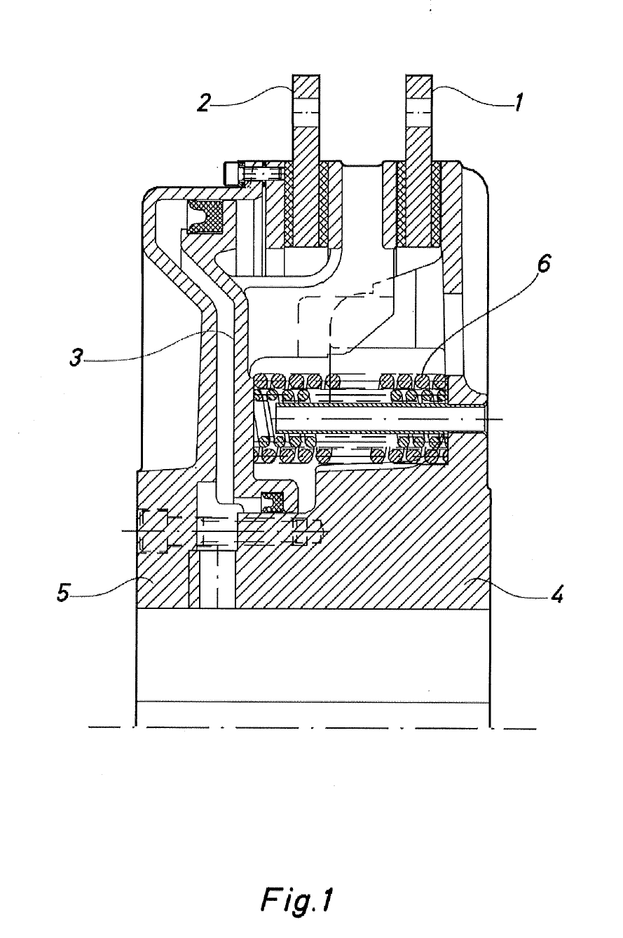

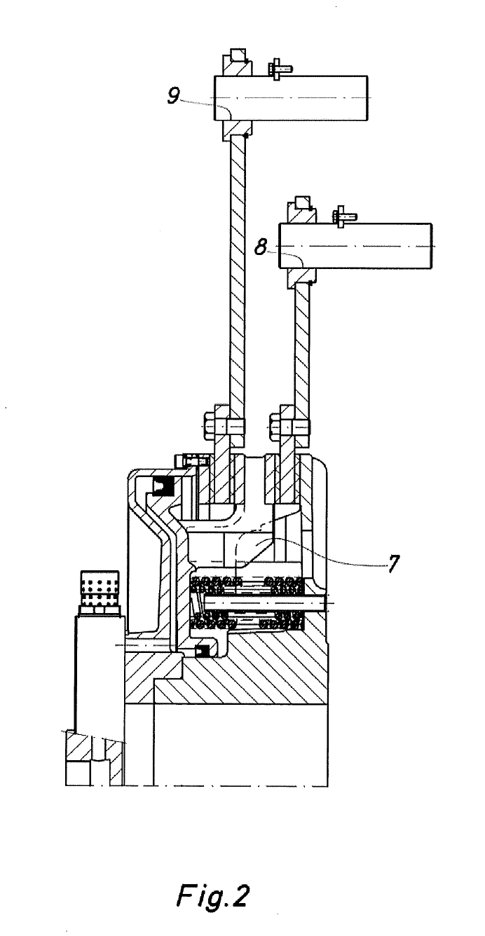

FIGS. 1 and 2 show an embodiment of a clutch and brake system according to the prior art.

Clutch torque is transmitted by friction in that the friction disk (or disks) 1 on the clutch side, which is axially movable and rotates integrally with the driving member (usually the flywheel), engages with the driven member. Brake torque is also transmitted by friction in that the friction disk (or disks) 2 on the brake side, which is axially movable and connected to the machine framework, engages with the driven member. The actual brake-clutch is attached to the shaft, the piston 3 being the element that is axially movable by the action of a fluid on one side and of the springs 6 on the other side; the piston pushes the friction disks alternately. The clutch side casing 4 and the brake side casing 5 are both rigidly connected to the shaft of the machine and complete the brake-clutch assembly. These units always have a series of plays which they require to operate correctly. In all of them the operating principle is the same—bolts or ribs restrict rotational movement (to transmit the torque) while allowing axial movement.

Specifically, conventional pneumatic brakes-clutches have three points where play is necessary to ensure relative movement between two parts.

1. The play 7 between the piston and the clutch side casing.
2. The play 8 between the friction disk bushing on the clutch side and the bolt or bolts integral with the flywheel. There are usually 2 bolts arranged at 180 degrees.
3. The play 9 between the friction disk bushing on the brake side and the bolt or bolts integral with the machine framework. There are usually 2 bolts arranged at 180 degrees.

For machines that work continuously at high rates, these plays are a drawback that affects the durability of the components concerned. The very definition of continuously operating machines implies that braking occurs very infrequently (in emergencies and for technical shutdowns) and, to that extent, the plays in the braking position are not important. However, the plays on the clutch side acquire relevant importance as in normal machine operation the variable torque generated by the machine kinematics cause the plays to intersect at a frequency proportional to the speed of rotation of the output shaft of the machine. The variable torque is caused in particular by two phenomena:

1. Force release of or snap through: Once the unfinished part is separated from the sheet, compression forces are released from the die components, causing a sudden positive or negative change in the press forces. In other words, when the press begins to cut the metal sheet, all the energy required to do so is stored in the structure of the press. Once the sheet has been cut, this energy instantaneously pushes the slide, producing a reverse force. This force is transmitted to the brake-clutch as reverse torque.
2. Inertia torque: Particularly in high speed, high inertia presses, the torque required to accelerate and decelerate the slide generates reciprocal torque in the brake-clutch. The inertia torque also changes from a high positive value to a high negative value and conversely from a high negative value to a high positive value. This effect occurs twice in every cycle.

These two factors together or each independently produce torque that changes direction, known as “fluctuating torque”, throughout the kinematic transmission, including the clutch-brake. This phenomenon means that each of the two components forming the connection with play (for example, the three points indicated in FIG. 2) impacts on the other on both sides. The high frequency at which the crossing of plays is produced causes premature component wear as well as additional effects such as noise and possible fracture. If the plays on one side intersect with those on the other side 4 times per machine revolution in a press working at 250 rpm, the plays intersect 16 times per second, which gives an idea of the accelerated fatigue damage these impacts may cause.

The greater the play, the greater the force to which the elements concerned are subjected. Therefore, once wear appears, the play increases and therefore the impact force rises, further increasing wear; the system therefore enters into a wear-impact spiral resulting in a possible breakage.

The present invention provides a solution to this problem by eliminating the chain of plays on the clutch side of the brake-clutch unit or separate clutch. The plays 7 and 8 (FIG. 2) are eliminated by replacing the classic “slide and contact” transmission with rotationally engaged rigid elements that are axially flexible and capable of transmitting the required torque. Preferably, these flexible elements are in the form of a multi-layer structure.

In particular, the present invention consists of a clutch and/or brake device for a machine, comprising at least an element which is axially movable along an axial shaft and at least a device body in which the axially movable element and the device body are joined by a connection device which, since the connection device is rigid relative to torsional stress about the axial shaft between the axially movable element and the body, comprises at least a flexible element attached by one of its points to the movable axial element and by another point to said body in such a way that a relative movement between the axially movable body and the body produces bending of the flexible element.

More particularly, said connection device preferably comprises at least a flexible element attached by one of its points to the movable axial element and by another point to said body in such a way that a relative movement between the axially movable body and the body produces bending of the flexible element.

Advantageously the flexible element is an elongated plate made of a material with resilient characteristics.

More preferably, the line joining the two connection points of the above-mentioned flexible element forms oblique angles to the imaginary radii that join said connection points to said axial shaft. In this way, torsional rigidity is achieved more simply.

The arrangement of the element or elements preferably comprises more than one flexible element like the one mentioned.

More preferably, said flexible elements are concatenated together in such a way that two contiguous flexible elements share one of said connection points.

Still more preferably, the concatenated flexible elements are arranged in the form of a polygon.

The invention may be used for brakes, clutches and combined brakes-clutches.

Thus, the movable axial element may be a piston and the body may be a casing on the clutch side. Alternatively, the movable element may be a friction disk and the body may be an element integral with a flywheel. Further, according to the present invention the device may have a connection in both places.

The main advantage introduced by this novel architecture on the clutch side of the combined clutch-brake unit or separate clutch is the elimination of plays in the transmission elements thus avoiding the wear, vibration and noise associated with the impacts to which the connections are subject, particularly in high speed machines working continuously and affected by significant fluctuating torque.

The useful life of the clutch-brake unit or clutch is therefore extended with the cost and repair or replacement time savings that this implies.

In addition, the novel play-free design is based on a standard Goizper clutch-brake unit so that the incorporated novelty is combined with compatibility with a highly dependable product.

For a better understanding of the invention the accompanying drawings are provided as an explanatory but not limiting example of an embodiment of a play-free clutch-brake assembly according to the present invention.

FIG. 1 is a cross-section through a transmission system according to the prior art.

FIG. 2 is a cross-section through a pneumatic clutch-brake assembly according to the prior art which comprises the known transmission system of FIG. 1.

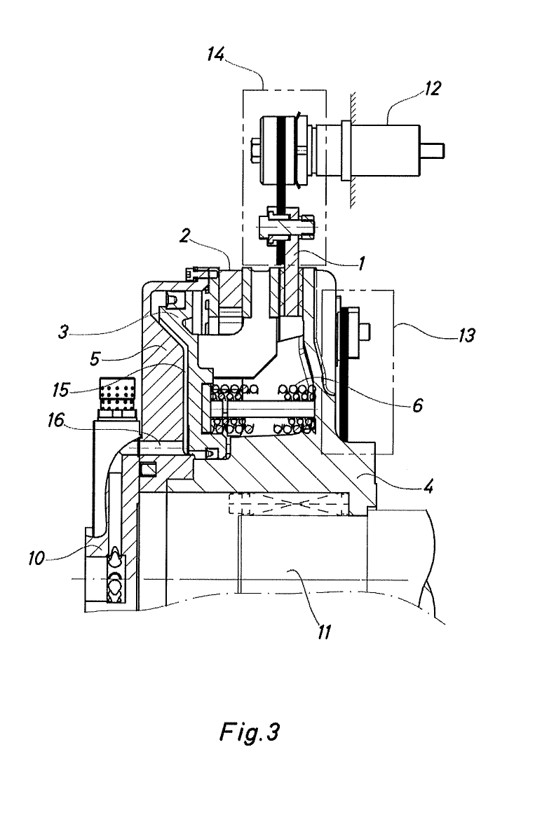

FIG. 3 is a cross-section through a clutch-brake system according to the present invention.

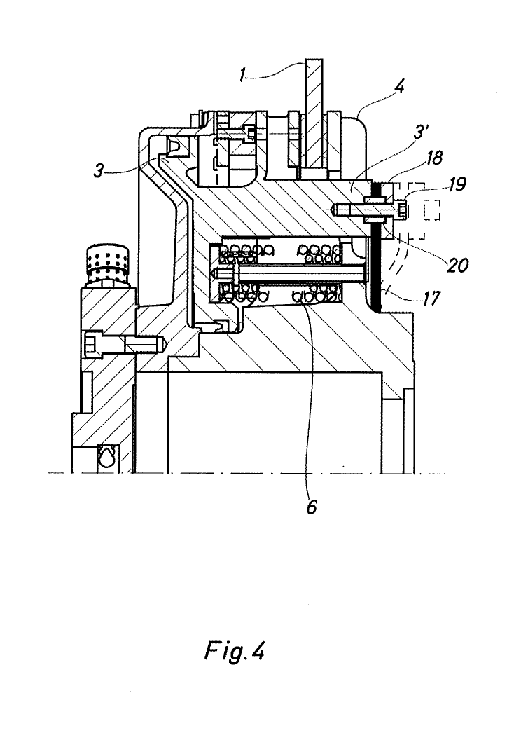

FIG. 4 is a cross-section through a detail of the system of FIG. 3.

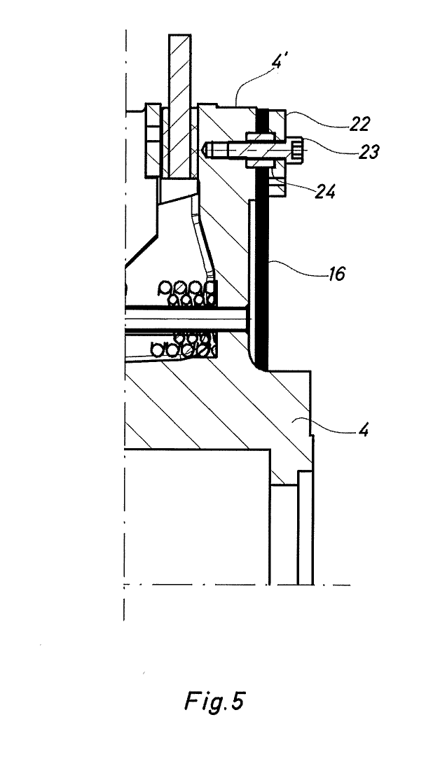

FIG. 5 is a cross-section through another detail of the system of FIG. 3.

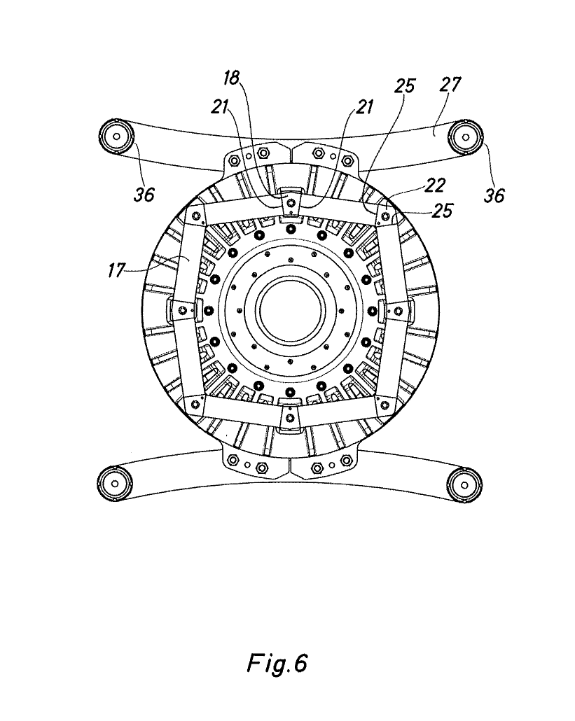

FIG. 6 is a front elevation of an example of transmission from the clutch friction disk to the flywheel, consistent with FIG. 5.

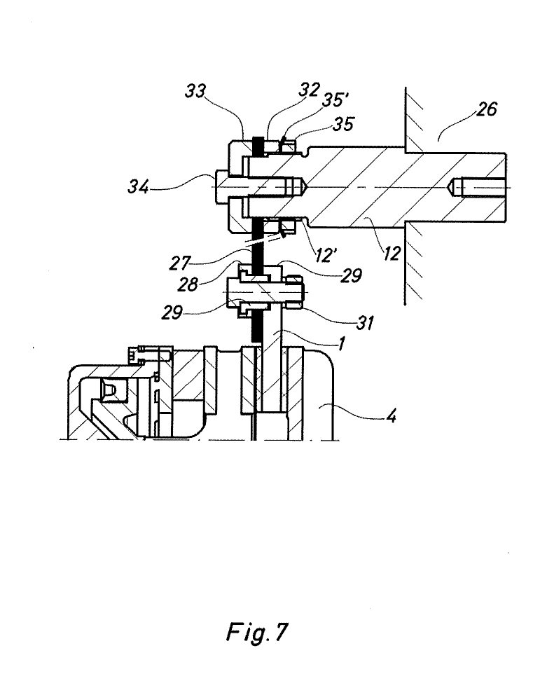

FIG. 7 shows a third detail of the embodiment of the present invention shown in the previous figures.

The clutch-brake unit or the clutch alone according to the present invention is based on the operation of a conventional clutch-brake in which the plays inherent in this type of system have been eliminated.

FIG. 3 shows that the clutch-brake or clutch consists of a central body 4, 5, 10 which is axially rigid and integral with the machine shaft. The friction disk on the brake side 2 may be connected to the machine frame (not shown in FIG. 3) or simply eliminated so that the unit only operates as a clutch. If there is a brake, when said brake is actuated the friction disk 2 moves axially and is blocked by the force of the springs 6, rendering the brake side disk 2 integral with the central body 4, 5, 10 and consequently causing the shaft 11 to stop. If the brake is eliminated, the springs trap the brake disk 2 (or pads) releasing the clutch and leaving the central unit 4, 5, 10 integral with the brake disk 2 (or pads) and the shaft 11 but without causing it to stop since the friction disk is not connected to the frame.

The clutch side friction disk 1 is attached to the press flywheel (in press applications) by respective bolts 12. When the clutch is actuated, the friction disk 1 is blocked, rendering it integral with the central body 4, 5, 10 and transmitting the movement and energy of the flywheel to the machine shaft 11. Transmission from the clutch is produced by respective play-free connection mechanisms 13, 14 which constitute the present invention and are described in detail in the following paragraphs.

The application of compressed air causes the piston 3 to move axially, trapping the clutch disk 1 (and releasing the brake disk 2), and it is returned to its initial rest position by means of the springs 6 when the air is expelled. The air which fills the chamber 15 may enter from a side inlet 10 or directly from the shaft (not shown in FIG. 3). Rotationally the piston is integral with the central body.

The elimination of play according to the present invention is achieved at two points of the clutch torque transmission mechanism:
zone 13 for torque transmission from the axially movable element (piston 3) to the central body of the unit 4, 5.
zone 14 for transmission from the clutch friction disk 1 to the flywheel (or driving member) of the machine.
   Torque Transmission from the Axially Movable Element (Piston) to the Central Body of the Unit

The system involves connecting the piston 3 to the clutch side casing 4 in a torsionally rigid manner while allowing the axial movement required for the engagement-disengagement operation. This connection is achieved by a series of sequentially bound or concatenated plates 17, the shape, size and quantity of which can be designed to optimise their torsional and bending strength. Moreover, this bending strength is combined with axial flexibility and its ability to apply the minimum possible force to counteract as little as possible the clutch force and consequently the clutch torque. The sequential binding or concatenation of the plates in the form of an octahedron is not limiting and may take another form depending on calculation requirements.

To connect the plates to the piston, said piston has a plurality of lugs 3′ which reach as far as the series of concatenated plates. The plates are held between the lug and a support 18 by tightening a screw 19. A tempered bushing 20 is responsible for guiding each lug to the corresponding aperture in the flexible plates. Bearing in mind that this connection will be highly stressed intermittently, its shape is designed specifically to reduce tension in the plate in the region of the edge 21 where said plate abuts the respective support.

Similarly, the clutch side casing 4 has a series of projections 4′ for housing the remaining connection points of the concatenated plates. The plates are held between said projection and a support 22 by tightening a screw 23. A tempered bushing 24 is responsible for guiding each projection to the corresponding aperture in the flexible plates. Like the previous connection (piston to plates), the support 22 in the example has a suitable shape 25 for reducing tensions in the plate 17.

The concatenated plates 17 therefore join the piston to the clutch side casing. When pressure is introduced into the chamber, the piston moves axially, deforming the concatenated plates which are held at the corresponding points of connection to the clutch side casing whereas they move with the piston at the points of connection thereto. The friction disk 1 is then blocked and begins transmission of the clutch torque which expands from the play-free connection points of the piston 3 to the connection points of the clutch side casing 4 by means of the concatenated plates (which are designed to withstand the twisting torque) to end at the machine shaft which is integral with the clutch side casing (by means of cotter pins or other attachment devices such as expansion rings). In this way, the movement of the flywheel is transmitted to the machine shaft.

While the press is working continuously, the clutch-brake unit (or clutch) is in the position described above. Any fluctuating torque produced will be absorbed by the system of flexible plates designed beforehand to withstand said torque which by definition will be less than the clutch torque; however, there is a risk that the clutch may slip. The play-free connections prevent impacts from being generated in the transmission, preventing the occurrence of premature wear and breakages.

Once the pressurised air in the chamber is removed by the disengagement command, the springs 6 cause the piston to move backwards and the concatenated plates return to the rest position, the unit being disengaged with the clutch disk released.

Transmission from the Clutch Friction Disk to the Flywheel (or Driving Member) of the Machine

The system consists of the play-free torsionally rigid connection of the clutch side friction disk 1 to the flywheel 26 while still allowing the axial movement required for the engagement/disengagement operation. This connection is achieved by means of bending concatenated supports 27, the shape, size and quantity of which are designed to optimise their bending strength. Like the connection between piston and clutch side casing, the rigidity of the bending supports results from the compromise between having sufficient capacity to transmit the torsional torque and having suitable flexibility so as not to over-counteract the clutch force.

The configuration of the half-moon shaped support is not limiting and may take another form depending on the calculated requirements.

The bundle of bending supports fits on one side into the bolts 12 which are integral with the flywheel and on the other side is connected to the friction disk 1.

As usual in conventional clutch-brake units, the friction disk has two halves; the bundle of bending supports is therefore pressed between a strip 28 which connects both halves of the friction disk and the half-disks themselves. Tempered centring bushings 29 and the corresponding screws 30 and nuts 31 complete the connection system.

The outer ends of the bending support are attached to bolts 12 integral with the flywheel. In this case, the bending supports are blocked between respective bushings 32, 33 which are axially attached by a screw 34 and a retaining nut 35. The shape of the bushings is designed to reduce the surface tension where the periphery 36 of the bushing is in contact with the bending support.

A system for adjusting the axial position of the friction disk has been incorporated on the bolt in order to ensure that said friction disk is released when the unit is disengaged. The bolt has a threaded portion 12′ on which the unit formed by respective bushings 32, 33 and the bundle of bending supports 27 can slide. Once the location of the friction disk has been decided (ensuring that it does not touch any of the clutch surfaces), the lock nut 35 together with the retaining washer 35′ axially delimit said position while the entire assembly is fixed with the screw 34.

The concatenated bending supports therefore connect the friction disk to the bolts of the flywheel. When pressure is introduced into the chamber, the piston moves axially and pushes the friction disks, axially deforming the bending supports through the zone of connection to the friction disk while a rigid connection to the bolts is maintained. When the piston movement is finished, the friction disk 1 is blocked against the clutch side casing 4 and transmission of the torque by means of the bending supports then begins.

When working continuously, any fluctuating torque is absorbed by the system of bending supports together with the corresponding play-free connection points, and this prevents premature wear and breakage of the bolts and bushings that house said bolts.

Once the pressurised air in the chamber is removed at the disengagement command, the springs cause the piston to move backwards and the concatenated bending supports, because of their resilient property, return to the rest position, the unit being disengaged with the clutch disk released.

Although the invention has been described with regard to preferred embodiments, these should not be considered as limiting the invention which will be defined by the widest interpretation of the following claims.

1. A clutch and/or brake device for a machine, comprising an element axially movable along an axial shaft and a body for the device, wherein the axially movable element and the body of the device are joined by a connection device that is rigid relative to torsional stress about the axial shaft between the axially movable element and the body, and wherein a flexible element is attached at one point to the movable axial element and at another point to said body in such a way that a relative movement between the axially movable element and the body produces bending of the flexible element.

2. The device of claim 1, wherein the flexible element is an elongated plate made of a material with resilient characteristics.

3. The device of claim 2, wherein the plate is a multi-layer plate.

4. The device of claim 2, wherein a line joining the two connection points of the flexible element forms oblique angles to the imaginary radii that join said connection points to said axial shaft.

5. The device of claim 1, comprising more than one flexible element.

6. The device of claim 5, wherein said flexible elements are concatenated together in such a way that two contiguous flexible elements share one of said connection points.

7. The device of claim 6, wherein the concatenated flexible elements are arranged in the form of a polygon.

8. The device of claim 1, wherein the axially movable element is a piston and the body corresponds to a casing on the clutch side.

9. The device of claim 1, wherein the axially movable element is a friction disk and the body is an element integral with a flywheel.

10. The device of claim 8 comprising at least two of said devices, one of the devices being joined to a piston and a casing on the clutch side and the other device being joined to a friction disk having an element integral with a flywheel.

11. The device of claim 2, wherein the connection of the plate or plates to the axially movable part and/or to said body comprises a lug or projection arranged on the axially movable part and/or on said body and a screwed connection which secures the plate to the lug or projection.

12. Device according to claim 11, wherein the connection also comprises a guide bushing for a screw of the screwed connection.

13. Device according to claim 9, further comprising a system for adjusting the axial position of the friction disk.
